(19) United States
(12) Patent Application Publication
(10) Pub. No.: US 2005/0223916 A1
(43) Pub. Date: Oct. 13, 2005

(54) Document enhancement apparatus

(76) Inventor: Hartmut H. Gerdes, Mill Valley, CA (US)

Correspondence Address: Erik M. Vieira;Vieira Consulting, Post Office Box 13593, La Jolla, CA, 92039, US

(21) Appl. No.: 10/816,515

(22) Filed: Mar. 31, 2004

(51) Int. Cl. B31F 1/07

(52) U.S. Cl. 101/3.1; 101/31.1; 101/26

(57) ABSTRACT

An apparatus for enhancing a document in a user customizable manner is disclosed. Enhancements to a document include precision die-cuts or embossing.

### BACKGROUND

1. Field of the Invention

The present invention relates generally to the field of handheld document enhancement apparatuss for use by an individual user.

2. Description of Related Art

The reader is referred to the following U.S. patent documents for general background material:

U.S. Pat. No. 6,325,263 discloses a movable upper tool for separating blanks comprises a base plate with apertures and on a lower side is provided with punches. The tool cooperates with a lower tool having separating bars for the separation of the blanks. The apertures of the upper tool are arranged along two orthogonal axes in an area, and one of these orthogonal axes consists of a line slanting with regard to one of the edges of the base plate of the movable tool, and at least one of the lateral sides of each of the cross sections of the punches is tangential to one of the apertures so that the space between the punches determines the total pressure identical to the punches on the blanks to be separated in the neighborhood of the separating bar, regardless of the position of the separating bar of the lower tool.

U.S. Pat. No. 4,736,660 discloses a rotary die-cut apparatus, in which a die roll cooperates with a resiliently covered anvil roll for die-cutting carton blanks passed therebetween, incorporates a constant mesh gear train between the die roll and the anvil roll for providing an infinite hunting ratio between the rolls. This provides more uniform wear of the anvil roll cover and prolongs its effective life. Preferably, this gear train includes a harmonic drive having a wave generator cam rotatable by a trim motor. An arrangement for sensing changes in diameter of the anvil roll due to wear of its cover may provide an input for determining the speed of the trim motor. A resurfacing mechanism for removing the outer surface of the cover when worn may provide this input. A pulse generator is preferably incorporated in a controller of the trim motor for periodically making random changes in the speed of the trim motor. The gear train, with or without the trim motor, preferably has a gear ratio through multiple pairs of gears which itself provides an infinite hunting ratio. A gear on the anvil roll concentric therewith may mesh inside an internally toothed ring gear, these gears remaining in mesh when the anvil roll is moved about an eccentric axis towards or away from the die roll. An electric register for registering the die roll may be interconnected with the trim motor for rotation of the anvil roll with the die roll when the apparatus is stopped.

U.S. Pat. No. 5,216,961 discloses a hand-held, manually operated book index notch cutter placed in the book to be notched. The notch cutter has a cylindrical cutting member which moves parallel to and rotates around its axis. The axis of the cylinder is perpendicular to the book leaves being notched. The cutting member rotates and advances within a cutter guide, which is attached to a thin base plate. The upper surface of the base plate is a resilient platen on which rests the stack of book leaves to be cut. These leaves are adjusted in fan and lateral angle with the help of a leaf guide, which is movable to allow a range of notch depths. The cutting member is attached to a knob, which is pressed and turned. Inside this cutting member-knob assembly is a spring-loaded ejector assembly. After a notch is cut, the ejector button is pressed, capturing the paper cuttings and raising the cutting member to the ready position. Then the entire index notch cutter is removed from the book and placed over a wastebasket, and the ejector button is released, causing the paper cuttings to fall.

U.S. Pat. No. 5,463,920 discloses a fabric notch cutter including a pair of inwardly facing shear edges which converge to a first apex and a pair of outwardly facing shear edges which converge to a second apex at a slightly lesser angle than the convergence angle of the inwardly facing shear edges. Each of the outwardly facing shear edges contacts a respective one of the inwardly facing shear edges at a contact point. Further, the outwardly facing shear edges are resiliently mounted such that they are retracted toward their support member during a cutting operation. The points of contact between the shear edges progress toward the apices during the cutting operation.

U.S. Pat. No. 6,018,849 discloses an improved paper clip member that comprises a back member having at least two edges that are disposed at substantially a right angle to one another, said back member having an extension member extending from a portion thereof that is structured to be the upper member that is placed in a clasping manner over the front or upper surface of the grouped papers with the back member placed against the back surface of the grouped papers, with the two perpendicular edges adapted to brace the adjoining perpendicular side edges of the grouped papers.

U.S. Pat. No. 6,018,850 discloses a clip for paper sheets, which is injection-molded in one piece from plastic. The clip in cross-section is U-shaped, the two legs interconnected by a web being flat and their flat sides face one another. In the gap formed in this way between the two legs is placed a clamping leg, which is connected in one piece to the inside of one leg and from there is inclined in the direction of the other leg and in the direction of the web. The paper sheets are slid into the gap, it being possible for the clamping leg to deform, whilst making difficult a drawing out of the sheets.

U.S. Pat. No. 4,869,143 discloses a pocket size punch mechanism provided to punch openings in cards or card-like objects, the punched openings have a cross-sectional configuration and spacing matching the configuration and spacing of a pair of rails in a commonly available card file. Also shown is mounting structure for adapting cards and card-like objects for mounting in the same type of two rail card file. A plurality of mounting members of a stiff stock material are fabricated on a sheet, the mounting members being individually removable from the sheet as needed to form a member having openings conforming to the configuration of the card file rails. A portion of the mounting member has adhesive thereon to secure to the back of the item to be mounted.

### SUMMARY OF THE INVENTION

In a first aspect of the invention, a document enhancement apparatus is disclosed, which has a body element having an upper body assembly connected to a lower body assembly at a predetermined point with a hinging element. In one embodiment, the upper assembly has an upper plate with at least one cutting member, and the lower assembly has a lower plate with at least one receptacle for receiving the cutting members.

In a second aspect of the invention, a document enhancement apparatus is disclosed, which has upper and lower plates, which swivel between a first position and a second position to allow a document to be inserted therebetween the plates.

In a third aspect of the invention, a document enhancement apparatus is disclosed, having an alignment tool useful to precisely align die-cuts.

In a fourth aspect of the invention, a document enhancement apparatus is disclosed, having at least one adjustable cutting member useful to customize patterns of cuts in a document.

In a fifth aspect of the invention, a document enhancement apparatus is disclosed, having a microprocessor controlled alignment tool useful for automated precision cutting of a document.

In a sixth aspect of the invention, a document enhancement apparatus is disclosed, having a microprocessor controlled cutting member.

In a seventh aspect of the invention, a document enhancement apparatus is disclosed, having a convex plate and a concave plate useful for embossing a document.

### BRIEF DESCRIPTION OF THE DRAWINGS

FIG. 1a is a front plan view of a first exemplary embodiment of the document enhancement apparatus according to the present invention in a closed position, with swivel plates in an unrotated position.

FIG. 1b is a rear plan view of the first exemplary embodiment of the document enhancement apparatus of FIG. 1a, showing a hinging element.

FIG. 1c is a side plan view of the document enhancement apparatus of FIG. 1a.

FIG. 1d is a bottom plan view of the document enhancement apparatus of FIG. 1a.

FIG. 1e is a top plan view of the document enhancement apparatus of FIG. 1a.

FIG. 1f is a side plan view of the document enhancement apparatus of FIG. 1a in an open position.

FIG. 1g is a front plan view of an exemplary embodiment of the document enhancement apparatus according to the present invention in the closed position, with the swivel plates in the rotated position.

FIG. 1h is a bottom perspective view of the document enhancement apparatus in the open position, with the swivel plates in the rotated position.

FIG. 2a is a top perspective view of an exemplary embodiment of the present invention, having an alignment tool in a closed position.

FIG. 2b is a top perspective view of the embodiment of FIG. 2a, having an alignment tool in an open and unrotated position.

FIG. 2c is a top perspective view of FIG. 2a in an open and rotated position.

FIG. 2d is a top perspective view of FIG. 2a in an open and rotated position, having a document therein.

FIG. 3 is a process diagram illustrating an exemplary embodiment of a manufacturing process according to the present invention.

### DETAILED DESCRIPTION OF THE INVENTION

The apparatus and method of the present invention are now described in terms of exemplary illustrative embodiments, wherein like numerals refer to like parts throughout.

### DETAILED DESCRIPTION OF EXEMPLARY EMBODIMENTS

As used herein, the term “digital processor” or “microprocessor” is meant generally to include all types of digital processing apparatuss including, without limitation, digital signal processors (DSPs), reduced instruction set computers (RISC), general-purpose (CISC) processors, microprocessors, and application-specific integrated circuits (ASICs). Such digital processors may be contained on a single unitary IC die, or distributed across multiple components. Exemplary DSPs include, for example, the Motorola MSC-8101/8102 “DSP farms”, the Texas Instruments TMS320C6x, or Lucent (Agere) DSP16000 series.

An illustrative exemplary embodiment of the present invention is now described. The document enhancement apparatus generally comprises a body element 100 composed of (i) an upper body assembly 101, (ii) a lower body assembly 103, and (iii) a hinge element 106, connecting the upper and lower assemblies. Generally speaking, a user puts the body element 100 into an open position, and then places a document in between the upper assembly 102 and lower assembly 103, then applies pressure to the upper 102 and/or lower 103 assemblies, thereby putting the apparatus into a closed position, to enhance the document. Enhancement of the document includes, inter alia, placing precision die-cuts on a document or precision embossing a document.

Upper Body Assembly

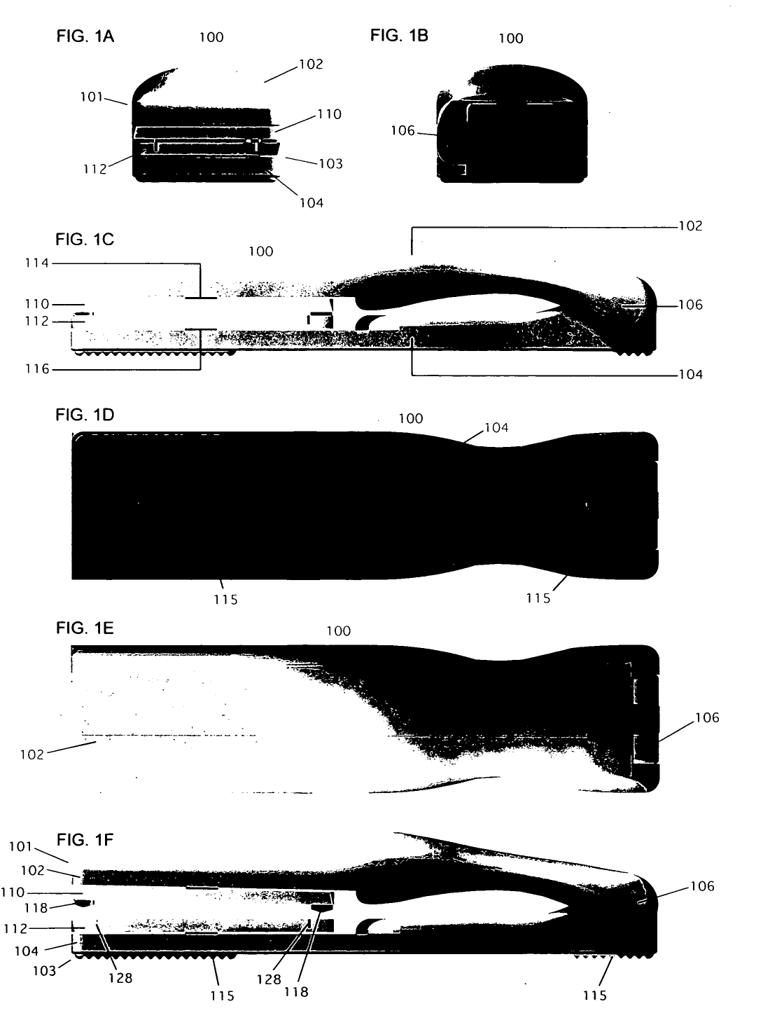

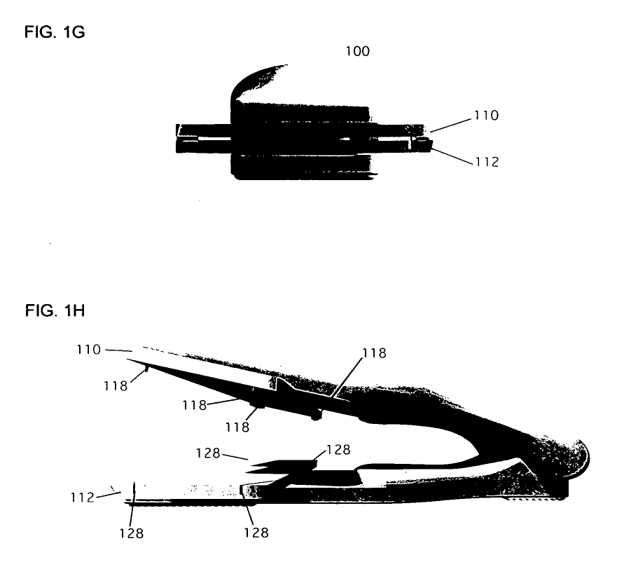

Referring now to FIGS. 1a-c, in the exemplary embodiment of the document enhancement apparatus, the upper body assembly 101 generally comprises an upper body element 102 connected by an upper connector element 114 to an upper plate 110. The upper connector element 114 can either permanently or temporarily connect body element 102 with plate 110. The upper body element 102 may be constructed of lightweight materials, well known in the art, such as for example, plastics, metal-alloys, rubber, ceramic, or made of stainless steel. In the illustrative exemplary embodiment, connector element 114 is a temporary connector, a connecting mechanism, of the type well known in the art, such as for example a bolt, pin, rivet, screw, nut-bolt arrangement, button-type snap, sleeve-type fitting or other type of fastening apparatus. In one embodiment, element 114 is a temporary connector, in the sense that the upper plate 110 can easily be removed and replaced with a different type of upper plate 110. For example, if a user wishes to use a different size, configuration or shape of die-cut or perhaps even replace the plate 110 with an embossing type plate, such a temporary connector is quite useful.

Another feature of the connector element 114 is the ability to provide a rotating (swiveling) connection between the upper body element 102 and the upper plate 110. This useful feature of the document enhancement apparatus allows the user to more easily place precision enhancements in a document, by affording the user with greater flexibility for positioning the apparatus.

Alternate embodiments include a non-rotating element 114, connecting upper body element 102 and plate 110. In such embodiments, the plate 110 remains static from rotation, positioned either parallel or perpendicular to the upper body element 102.

The upper plate 110 has an upper surface and a lower surface. The upper surface of the plate 110 contains a portion of the connecting element 114 for connecting to a corresponding portion of the connecting element 114 attached to a lower surface of the upper body element 102. As mentioned above, the connecting element 114 may be a temporary connector, wherein the upper plate 110 upper surface can effectively connect to the lower surface of the upper body element 102.

Lower Body Assembly

The lower body assembly 103 generally comprises a lower body element 104, connected by a lower connector element 116 to a lower plate 112. The lower body element 104 may be constructed of lightweight materials, well known in the art, such as for example, plastics, metal-alloys, rubber, ceramic, or stainless steel. The lower connector element 116 can either permanently or temporarily connect body element 104 with plate 112. In the illustrative exemplary embodiment, connector element 116 is a temporary connector, having a connecting mechanism, of the type well known in the art, such as for example a bolt, pin, rivet, screw, nut-bolt arrangement, button-type snap, sleeve type fitting or other type of fastening apparatus. Element 116 is a temporary connector, in the sense that the lower plate 112 can easily be removed and replaced with a different type of lower plate 112. For example, if a user wishes to use a different size, configuration or shape of die-cut or perhaps even replace the plate 112 with an embossing-type plate, such a temporary connector is quite useful.

Another feature of the connector element 116 is the ability to provide a rotating (swiveling) connection between the lower body element 104 and the lower plate 112. This useful feature of the document enhancement apparatus allows the user to more easily place precision enhancements in a document, by affording the user with greater flexibility for positioning the apparatus.

Alternate embodiments include a non-rotating element 116 connecting lower body element 104 and plate 112. In such embodiments, the plate 112 remains static from rotation, positioned either parallel or perpendicular to the lower body element 104.

The lower plate 112 has an upper surface and a lower surface. The lower surface of the plate 112 contains a portion of the connecting element 116, for connecting to a corresponding portion of the connecting element 116 attached to an upper surface of the lower body element 104. As mentioned above, the connecting element 116 may be a temporary connector, wherein the lower plate 112 lower surface can effectively connect to the upper surface of the lower body element 104.

Hinging element 106 connects via a hinge upper assembly 101 with lower assembly 103 at a predetermined point. In the exemplary embodiment, the predetermined point comprises one of the mutual endpoints of the upper 101 and lower 103 assemblies, as shown in FIG. 1b-c. The hinging element 106 can be made of any number of hinge-type mechanisms well known in the art, such as for example, a leaf spring, a hinge, or coil spring(s). The function of the hinging element 106 is to provide a restoring force to keep the upper 101 and lower 103 assemblies in an open position. The open position occurs when the assemblies 101 and 103 are in their furthest position, with respect to each other.

During the operation of the document enhancement apparatus, a user places a document in between the upper 101 and lower 103 assemblies, with the apparatus in the open position, and proceeds to squeeze the apparatus, with the user's hand, to push the assemblies 101 103 into physical contact with the document, thereby putting the apparatus in the closed position. The functions performed by the apparatus will be further disclosed below, with respect to various embodiments.

Alternative embodiments of the invention include other ways to put the apparatus into the closed position including, inter alia, microprocessor control.

Referring now to FIG. 1d, traction elements 115 of the exemplary embodiment are illustrated. The traction elements can be made of any type of non-slip materials, including, inter alia, anti-slip rubberized surfaces, velcro, magnetic surfaces, rubber or soft-plastics. The traction elements 115 may be positioned as illustrated in FIG. 1d, on the bottom surface, but may also be positioned in alternative ways, which optimize the function of not slipping from a user's hand, or from slipping off of a desk-type surface.

Referring now to FIG. 1e, in the exemplary embodiment it will be appreciated that the top surface of the document enhancement apparatus will be shaped to fit comfortably and stably within the hand of a human user. See also FIG. 1f for the contours of the top surface of the enhancement apparatus, which help optimize the comfort and stability of the apparatus within the hand of a human user.

Alternate embodiments of the invention include placing traction elements on the top surface of the apparatus.

Referring now to FIG. 1f and FIG. 1h, a plurality of cutting members 118 are illustrated, extending from the lower surface of the upper plate 110. The cutting members 118 can be constructed from a variety of materials, including for example metal, metal alloy, plastic, and ceramics, or be made from stainless steel. In the exemplary embodiment of the invention, the members 118 comprise thin metal strips with sharp points for slicing a document. The function of the cutting members 118 is to perform the actual die-cut in the document. That is, the function of the cutting members 118 is to cut small slices in the document in a precise way, to enable the insertion of an item. Examples of items that can be inserted include, but are not limited to, business cards and photographs.

Alternative embodiments of the invention include at least one cutting member 118 extending from the lower surface of the upper plate 110. Additional embodiments include a cylindrical configuration of the cutting member 118, which cuts, inter alia, a circular, oval, rectangular or square cut in the document. In the additional embodiments, the height of the cutting member 118 may vary. That is, certain portions of the cutting member 118 may reach the document before other portions of the cutting member 118.

The lower plate 112 upper surface has a plurality of receptacles 128 for receiving the plurality of cutting members 118 therein. As such, the plurality of receptacles 128 are designed to receive the plurality of cutting members 118 at least partially inside the receptacles 128. In the exemplary embodiment, the receptacles 128 comprise narrow slits angled to receive the cutting members 118 therein.

Alternate embodiments of the invention include at least one receptacle 128 for receiving at least one cutting member 118 therein.

Referring now to FIG. 1g, a front plan view of the exemplary embodiment of the document enhancement apparatus with upper plate 110 and lower plate 112 in the rotated position is shown. In the exemplary embodiment, the rotated position of the plates 110 112 is substantially at right angles with respect to the body element 100. The unrotated position of the plates 110 112 is shown in FIG. 1a-f. It will be appreciated that the user can use the document enhancement apparatus in either the unrotated or the rotated positions. One of the useful features of having a rotational ability of the plates 110 112 is that the user has greater flexibility to position the apparatus on the document. Another useful feature of the rotational aspect of the apparatus is the alignment of the apparatus and document with an alignment tool, as will be discussed further below.

The Plates 111 and 112

Generally speaking, the upper 110 and lower 112 plates are rotated or unrotated by the user. In the illustrative exemplary embodiment, the document enhancement apparatus comprises cutting members 118 configured to slice four precision cuts in a document, as shown in FIG. 1h.

In some embodiments the plates 110 112 may vary in size, dimensionality, configuration of cutting members 118, and configuration of receptacles 128 without departing from the inventive scope of the invention. That is, the plates may be custom designed to conform to varying sizes of documents and to conform to various arrangements of cutting members 118, depending on the document enhancement requirements. Such document enhancement requirements will depend upon the number of precision die-cuts needed in the document to affix an item. Items a user may desire to affix to a document include, inter alia, business cards, photographs, and advertisements. The plates 110 112 may either be permanently attached to the body 100 or removable. Some examples of specific documents a user may wish to enhance include, inter alia, a resume, business proposal, transmittal letters, applications, advertisements, cover sheets, and folders.

Additionally, the plates 110 112 may comprise precision embossing tools having one plate comprising a convex portion and the other plate comprising a concave portion. In one exemplary embodiment, the lower plate 112 has the convex portion, and the upper plate 110 has a corresponding concave portion. When the user squeezes the document enhancement apparatus together, the plates apply pressure to the document, thereby deforming the document in a precision way, based upon the plates 110 112 respective concavity and convexity.

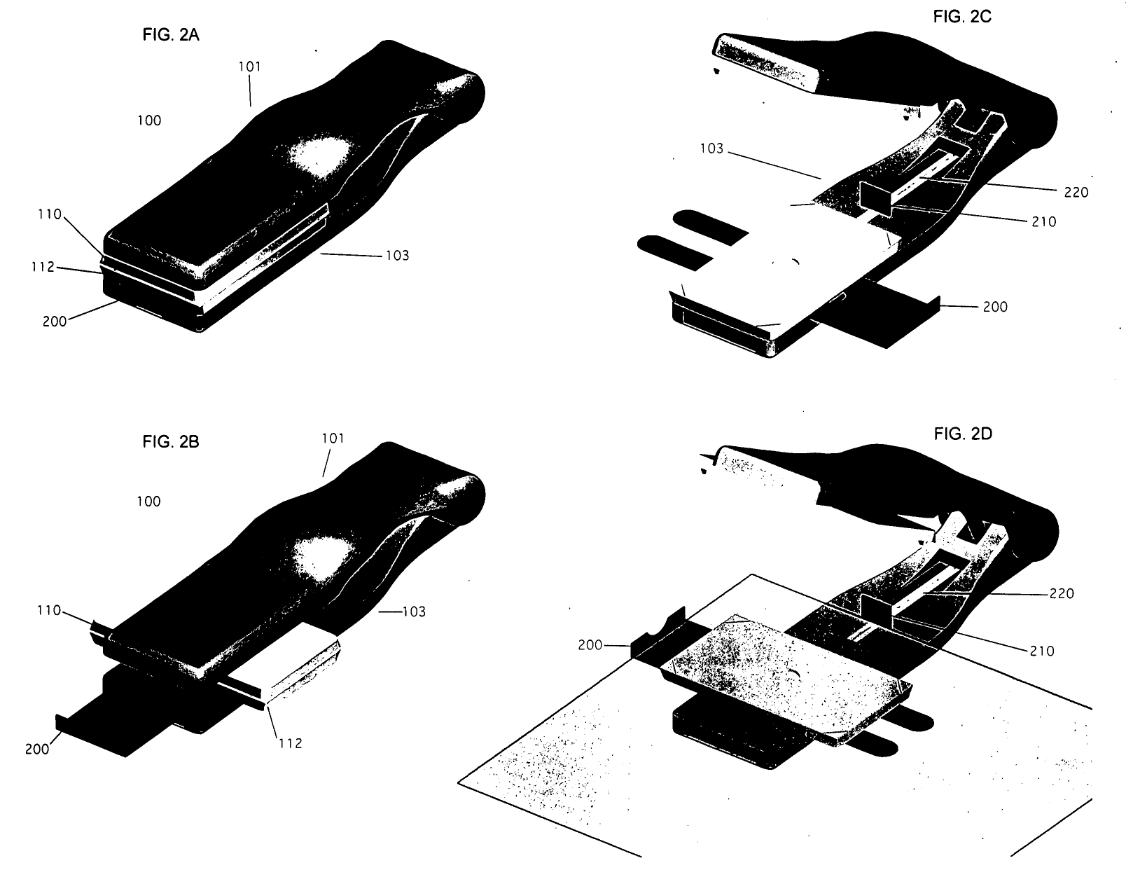

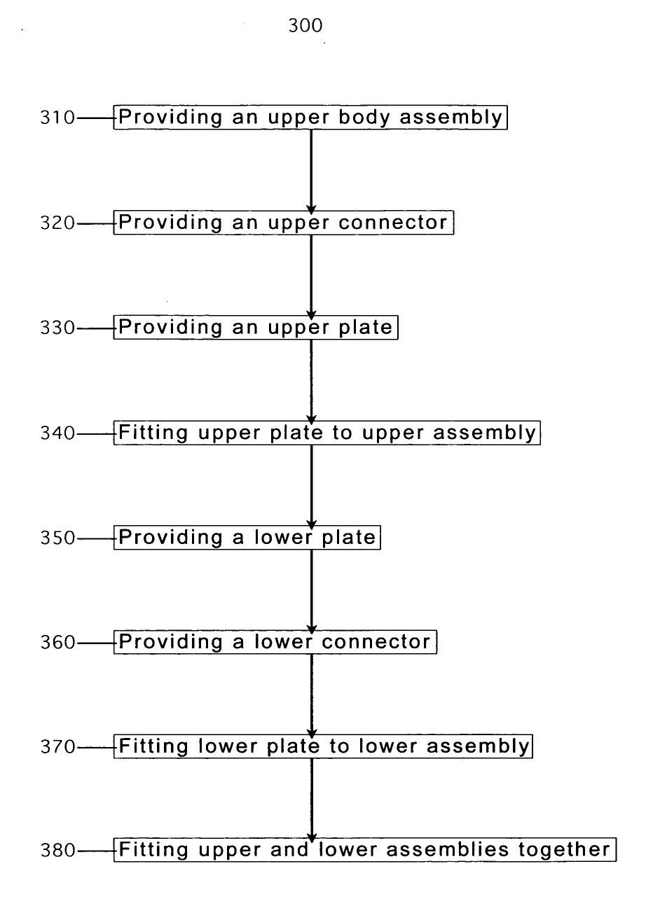

Referring now to FIG. 2a, an alternate illustrative exemplary embodiment of the present invention is shown, having an alignment tool 200. During non-operation, the body element 100 protects the tool 200 from damage by being inserted inside the body 100, as shown. Although the alignment tool 200 is illustrated as being positioned within the lower assembly 103, it will be appreciated that additional alternate embodiments of the invention may include an alignment tool 200 being positioned within the upper assembly 101. It will be appreciated that the plates 110 112 are in the unrotated position.

Referring now to FIG. 2b, the tool 200 is partially withdrawn from the body 100. The function of the alignment tool 200 is to aid the user in properly aligning (squaring) a document ready for enhancement. Enhancements can be precision placements of die-cuts, or precision placements of embossing features, or both simultaneously, as will be discussed herein. Depending upon the size of the document the user wishes to enhance, the tool 200 has several settings. In this context, the tool's 200 settings correspond to the distance the tool 200 is withdrawn from the body 100, and also the angle of the tool 200, with respect to the body 100. It will be appreciated that in this illustration, the plates 110 112 are in the rotated position.

Referring now to FIG. 2c, the tool 200 is in a rotated position, with respect to the body 100, and the plates 110 112. Generally speaking, the rotated position (of either the tool 200 or the plates 110 112) comprises an angle with respect to the body 100 that is greater than zero. In the illustrated exemplary embodiment, the rotated angle is substantially ninety degrees, however, it will be appreciated that other angles comprise the rotated position also, depending upon the document requiring treatment.

A backstop 210 is useful to the user in aiding in the alignment of the document, which requires enhancement. The backstop 210 is anchored in place by a channel 220. The channel functions to allow the backstop 210 to slide along the length of the lower assembly 103, in order to accommodate varying sizes of documents. The backstop 210 may be anchored to the channel 220 in any number of ways well know in the art, such as for example, a snap-button arrangement or male and female notches, respectively.

Referring now to FIG. 2d, the illustrative embodiment of the document enhancement apparatus is shown in the open position, with the plates 110 112 in the rotated position, and the alignment tool 200 in the rotated position. Additionally, this illustration shows a document aligned utilizing the backstop 210 and the tool 200.

Alternate embodiments of the present invention includes digital processor control of the document enhancement apparatus. Such embodiments comprise, inter alia, digital processor control of the rotation of the plates 110 112, application of precision force to optimize the cutting/embossing features respectively, and proper alignment of the document within the apparatus.

Referring now to FIG. 3, a process diagram 300 of a method of manufacturing the document enhancement apparatus is disclosed. Step 310, providing an upper body assembly may be achieved in several ways, such as for example, by obtaining such an assembly from a vendor, or custom-molding the assembly. Step 320, providing an upper connector to fit an upper plate to the upper assembly, can be obtained either through a third party vendor or custom molded. Step 330 in the process comprises providing an upper plate, having either customized cutting members or embossing concavity or convexity, may be obtained through a third party vendor or custom-molded. Step 340 in the process requires that the upper plate be fitted onto the upper assembly, utilizing the upper connector. Step 350, providing a lower plate comprises providing a lower plate, having either customized cutting members or embossing concavity or convexity, and may be obtained through a third party vendor or custom-molded. Step 360 in the process requires providing a lower connector to fit a lower plate onto the lower assembly, which can be obtained through a vendor or custom molded. Step 370 requires fitting the lower plate onto the lower assembly, utilizing the lower connector, as provided in the steps above. Step 380 utilizes a process whereby the upper and lower assemblies are fitted together at a predetermined point, such as for example at one common endpoint of the assemblies.

It will be further recognized that while certain aspects of the invention have been described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described and pointed out novel features of the invention as applied to various embodiments, it will be understood that various omissions, substitutions, and changes in the form and details of the apparatus or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

1. a document enhancement apparatus having a body element, comprising:
an alignment tool connected to said body element;
an upper body assembly comprising:
an upper body element having an upper connector element rotatably connecting an upper plate to said upper body element;
said upper plate has an upper surface and a lower surface;
said upper plate upper surface having a connecting point for said upper connector element to rotatably connect said upper plate to said upper assembly;
said upper plate rotates between a first position and a second position;
said upper plate lower surface having a plurality of cutting members attached thereto;
a lower body assembly comprising:
a lower body element having a lower connector element rotatably connecting a lower plate to said lower body element;
said lower plate rotates between a first position and a second position;
said lower plate has an upper surface and a lower surface;
said lower plate lower surface having a connecting point for said lower plate connector element to rotatably connect said lower plate to said lower assembly;
said lower plate upper surface having a plurality of receptacles for receiving said plurality of cutting members, and;
a hinging element connecting said upper assembly and said lower assembly at a predetermined position.

2. The apparatus of claim 1, further comprising:
a traction element connected to said upper assembly.

3. The apparatus of claim 1, further comprising:
a traction element connected to said lower assembly.

4. The apparatus of claim 2, further comprising:
a traction element connected to said lower assembly.

5. The apparatus of claim 1, further comprising:
said alignment tool being rotatably connected to said body element.

6. The apparatus of claim 4, further comprising:
said alignment tool being rotatably connected to said body element.

7. (canceled)

8. (canceled)

9. (canceled)

10. A document enhancement apparatus having a body element comprising:
an upper body assembly comprising:
an upper body element having an upper connector element physically connecting an upper plate to said upper body element;
a lower body assembly comprising:
a lower body element having a lower connector element physically connecting a lower plate to said lower body element, and;
a hinging element hingeably connecting said upper assembly and said lower assembly at a predetermined position.

11. The document enhancement apparatus of claim 10, further comprising:
the upper plate rotatably connected to the upper body element,
said upper plate rotates between a first position and a second position;
said lower plate rotates between a first position and a second position, and;
the lower plate rotatably connected to the lower body element.

12. The document enhancement apparatus of claim 10, further comprising:
the upper plate being removeably connected to the upper assembly, and;
the lower plate being removeably connected to the lower assembly.

13. The document enhancement apparatus of claim 11, further comprising:
the upper plate being removeably connected to the upper assembly, and;
the lower plate being removeably connected to the lower assembly.

14. The document enhancement apparatus of claim 10, further comprising:
the upper plate having at least one cutting member which is adapted to cut at least one cut in a document in at least one predetermined position, and;
the lower plate having at least one receptacle adapted to receive the at least one cutting member therein.

15. The document enhancement apparatus of claim 11, further comprising:
the upper plate having at least one cutting member which is adapted to cut at least one cut in a document in at least one predetermined position, and;
the lower plate having at least one receptacle adapted to receive the at least one cutting member therein.

16. The document enhancement apparatus of claim 12, further comprising:
the upper plate having at least one cutting member which is adapted to cut at least one cut in a document in at least one predetermined position, and;
the lower plate having at least one receptacle adapted to receive the at least one cutting member therein.

17. The document enhancement apparatus of claim 13, further comprising:
the upper plate having at least one cutting member which is adapted to cut at least one cut in a document in at least one predetermined position, and;
the lower plate having at least one receptacle adapted to receive the at least one cutting member therein.

18. The document enhancement apparatus of claim 10, further comprising:
the body element having an alignment tool.

19. The document enhancement apparatus of claim 11, further comprising:
the body element having an alignment tool.

20. The document enhancement apparatus of claim 12, further comprising:
the body element having an alignment tool.

21. The document enhancement apparatus of claim 13, further comprising:
the body element having an alignment tool.

22. The document enhancement apparatus of claim 14, further comprising:
the body element having an alignment tool.

23. The document enhancement apparatus of claim 15, further comprising:
the body element having an alignment tool.
